(19) United States
(12) Patent Application Publication
(10) Pub. No.: US 2024/0088937 A1
(43) Pub. Date: Mar. 14, 2024

(54) ELECTRONIC DEVICE AND METHOD FOR WIRELESS DATA TRANSMISSION

(71) Applicant: GLS CO., LTD., Daejeon (KR)

(72) Inventors: Ki Dong SONG, Daejeon (KR); Ki Chan EUN, Daejeon (KR); Hye Min LEE, Sejong-si (KR); Won Ki JU, Daejeon (KR)

(73) Assignee: GLS CO., LTD., Daejeon (KR)

(21) Appl. No.: 18/037,431

(22) PCT Filed: Nov. 25, 2020
(86) PCT No.: PCT/KR2020/016758

§ 371 Date: May 17, 2023

(30) Foreign Application Priority Data
Nov. 18, 2020 (KR) 10-2020-0154448

(51) Int. Cl. H04B 1/54; H04L 25/03

(52) U.S. Cl. CPC H04B 1/54; H04L 25/03

(57) ABSTRACT

Proposed is a wireless data transmission method including: converting a control signal received from an external device into a second RF signal having a second frequency band; transmitting and/or receiving the second RF signal; reconverting the second RF signal into the control signal; converting, in a transmitter on the basis of the control signal, a display signal into a first RF signal having a first frequency band distinct from the second frequency band; transmitting and/or receiving the first RF signal; and converting, in a receiver, the received first RF signal into the display signal.

### TECHNICAL FIELD

Various embodiments of the present disclosure relate to a device and a method for ultra-high-speed wireless data transmission.

### BACKGROUND ART

As interface methods for data transmission in display devices, interfaces based on wired communication, such as Digital Video Interface (DVI), High-Definition Multimedia Interface (HDMI), DisplayPort, V-by-One, etc., are commercialized.

However, as the enlargement and high-resolution of displays have rapidly progressed recently, there is an exponentially increasing demand for an increase in an amount of data to be transmitted between electronic devices and in data transmission rate. For electronic devices such as TVs, PCs, and smartphones as well as wearable electronic devices such as augmented reality (AR), virtual reality (VR), and mixed reality (MR) devices, there is an increasing need for ultra-high-speed transmission of a large amount of data because of high precision of display resolution, transmission of omnidirectional image information, and real-time transmission of image information. In addition, there is a continuously increasing demand for ultra-high-speed real-time data transmission because of the addition of various sensors such as high-resolution cameras and ToF sensors. It is technically easy to perform such ultra-high-speed data communication through wired communication. However, since electronic devices have gradually become mobile, there is a significantly increasing preference for the ultra-high-speed data communication to be performed in a wireless manner.

This trend is equally applied to mobile communication. In order to meet the increasing demand for wireless data traffic after the commercialization of 4th-generation (4G) mobile communication systems, next-generation (e.g., 5G or 6G) communication systems are trying to achieve a faster wireless data communication rate. As part of this effort, in the next-generation communication systems, wireless communication using an extremely high frequency (EHF) band (30 to 300 GHz) has been realized to achieve a high data transfer rate.

Therefore, technologies that aim to apply communication in this extremely high-frequency band to data transmission in displays and electronic devices have been discussed.

### SUMMARY OF THE DISCLOSURE

### Technical Problem

In utilizing technologies such as augmented reality (AR), virtual reality (VR), mixed reality (MR), etc., wired data communication is used to transmit a large amount of real-time data at high speed between a wearable display device and a control device.

When virtual reality-related technologies are utilized on the basis of such wired communication, especially for sports purposes, communication lines may restrict movement, and there is a possibility of line disconnection due to movement.

### Technical Solution

According to an embodiment, there is provided a wireless data transmission method including: converting a control signal received from an external device into a second RF signal having a second frequency band; transmitting and/or receiving the second RF signal; reconverting the second RF signal into the control signal; converting, in a transmitter on the basis of the control signal, a display signal into a first RF signal having a first frequency band distinct from the second frequency band; transmitting and/or receiving the first RF signal; and converting, in a receiver, the received first RF signal into the display signal.

According to an embodiment, there is provided an electronic device with a transmitter and a receiver, the electronic device including: a first communication channel for transmitting and receiving a first RF signal in a first frequency band between the transmitter and the receiver; and a second communication channel for transmitting and receiving a second RF signal in a second frequency band distinct from the first frequency band between the transmitter and the receiver, wherein the first communication channel may include: a first convertor, in the transmitter, for converting a display signal into a digital signal; a first radio-frequency integrated circuit (RFIC) for converting the digital signal into the first RF signal and transmitting the first RF signal; a second RFIC, in the receiver, for receiving the first RF signal and converting the first RF signal into the digital signal; and a second convertor for converting the digital signal into the display signal, and wherein the second communication channel may include: a third RFIC, in the transmitter, for converting a control signal into the second RF signal and transmitting the second RF signal; and a fourth RFIC, in the receiver, for receiving the second RF signal and converting the second RF signal into the control signal.

According to an embodiment, a first communication channel may be a communication channel for transmitting and receiving control signals for controlling electronic devices, and a second communication channel may be used for communication for data transmission and reception to transmit large amounts of data at ultra-high speed according to the control signals through the first communication channel. Herein, the first communication channel may be configured as a low-speed communication channel for transmitting and receiving a low-capacity control signal, and the second communication channel may be configured as an ultra-high-speed communication channel for transmitting a large amount of data. Alternatively, the two communication channels may use the same frequency band.

### Advantageous Effects

The present disclosure relates to a device for performing data transmission and/or reception in a display device by using wireless data communication.

In addition, according to the present disclosure, a signal in a millimeter wave (mmWave) frequency band is used to transmit and receive a signal of a display device, thereby transmitting and receiving a large amount of data in real time.

In addition, according to the present disclosure, a signal in an extremely high frequency band is used to transmit and receive a signal of a display device, thereby transmitting and receiving a large amount of data at high speed.

In addition, according to the present disclosure, a control signal and a display signal are transmitted and received on the basis of wireless communication, thereby securing the freedom of user movement.

In addition, according to the present disclosure, without using an additional data protocol for wired transmission, high-speed data is transmitted or received by being immediately changed into a format capable of mmWave transmission so that additional hardware or controllers for conversion of a wired transmission format back into an mmWave format are not required, thereby maximizing transmission efficiency.

Effects that may be obtained from the various embodiments of the present disclosure will not be limited to only the above described effects. In addition, other effects which are not described herein will become apparent to those skilled in the art from the following description.

### BRIEF DESCRIPTION OF THE DRAWINGS

FIG. 1 shows a communication structure according to an embodiment.

FIG. 2 shows a communication structure of converting a display signal into a wireless signal for communication according to an embodiment.

### BEST MODE FOR CARRYING OUT THE INVENTION

Advantages and features of embodiments of the present disclosure, and methods to achieve the same will be apparent from the following embodiments that will be described in detail with reference to the accompanying drawings. However, the present disclosure may be embodied in many different forms, and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Throughout the description, the same reference numerals refer to same elements.

In the following description, when it is determined that a detailed description of a known function or element related with the present disclosure makes the gist of the present disclosure unclear, the detailed description will be omitted. Further, the terms described below defined considering functions in the embodiments of the present disclosure may vary depending on the intention of the user, the operator, or the custom. Therefore, the definitions should be based on the contents throughout this specification.

Hereinafter, exemplary embodiments of the present disclosure will be described with reference to the accompanying drawings.

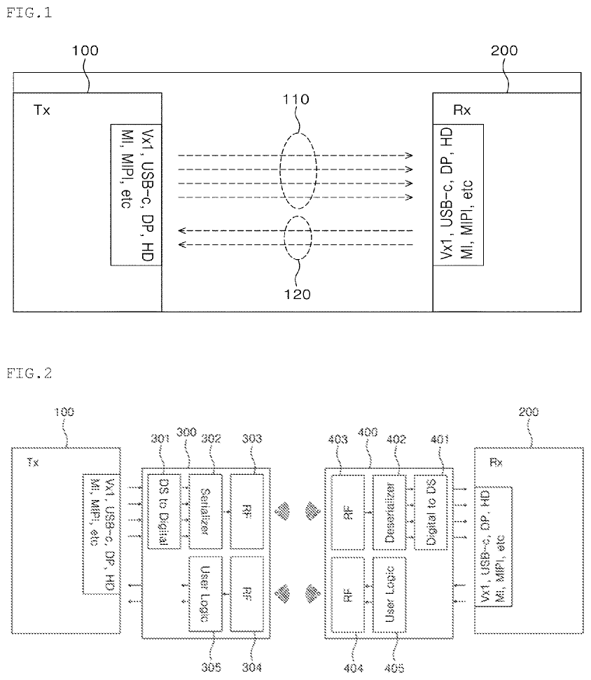

FIG. 1 shows a communication structure according to an embodiment.

Referring to FIG. 1, a communication structure according to an embodiment may include a transmitter 100 (for example, V-by-One (Vx1) Tx or Universal Serial Bus (USB) type-C Tx), and a receiver 200 (for example, Vx1 Rx or Universal Serial Bus (USB) type-C Rx).

According to an embodiment, the transmitter 100 may be a part of an electronic device (for example, a smartphone, a home appliance, a wearable device) connected to a wearable device. According to another embodiment, the transmitter 100 may be at least a part of a USB type-C connection part.

According to an embodiment, the receiver 200 may be at least a part of a wearable display device that supports augmented reality (AR), virtual reality (VR), or mixed reality (MR). According to another embodiment, the receiver 200 may be at least a part of a connector connected to a USB type-C connection part, but the transmitter 100 and the receiver 200 are not limited to the above-described examples.

According to an embodiment, the transmitter 100 and the receiver 200 may be operatively connected. According to an embodiment, the transmitter 100 and the receiver 200 may be wirelessly connected through a wireless communication protocol. According to an embodiment, the transmitter 100 and the receiver 200 may be connected through a first communication channel 110 and a second communication channel 120. For example, the transmitter 100 and the receiver 200 may be operatively connected through mmWave communication and/or ultra-wide band (UWB) communication, but are not limited thereto.

According to an embodiment, the transmitter 100 and the receiver 200 may transmit and/or receive a first signal (for example, mmWave signal) in a first frequency band ranging from GHz to 300 GHz through the first communication channel 110. According to an embodiment, the transmitter 100 and the receiver 200 may transmit and receive a second signal (for example, UWB signal) in a second frequency band ranging from 3 GHz to 30 GHz through the second communication channel 120, wherein the second frequency band is lower than the first frequency band. The transmitter 100 and the receiver 200 may transmit and receive a large amount of data through the first communication channel 110, and may transmit and receive a small amount of data through the second communication channel 120. For example, the first communication channel 110 may form a main link through which a large amount of data is transmitted and received, and the second communication channel 120 may form an auxiliary line through which auxiliary signals (for example, LOCKN and HTPDN) are transmitted and received, but are not limited thereto.

According to an embodiment, the transmitter 100 may transmit a first signal to the receiver 200. According to an embodiment, the transmitter 100 may transmit a first signal to the receiver 200 through the first communication channel 110. For example, the transmitter 100 may transmit a signal in an mmWave frequency band to the receiver 200 through the first communication channel 110. According to another embodiment (not shown), the receiver 200 may transmit a first signal to the transmitter 100 through the first communication channel 110. The directions of transmission and reception of signals through the first communication channel 110 are not limited to the above-described examples.

According to an embodiment, the receiver 200 may transmit a second signal to the transmitter 100. According to an embodiment, the receiver 200 may transmit a second signal to the transmitter 100 through the second communication channel 120. For example, the receiver 200 may transmit a signal in an UWB frequency band (3 GHz to 30 GHz) to the transmitter 100 through the second communication channel 120. According to another embodiment (not shown), the transmitter 100 may transmit a second signal to the receiver 200 through the second communication channel 120. The directions of transmission and reception of signals through the second communication channel 120 are not limited to the above-described examples. For example, in order to enable two-way communication, in transmission and/or reception of signals, the roles of the transmitter 100 and the receiver 200 may be switched.

According to an embodiment, transmission and/or reception of a first signal through the first communication channel 110 may be controlled by a second signal. For example, the transmitter 100 may transmit, on the basis of a second signal received from the receiver 200, a first signal to the receiver 200 through the first communication channel 110. As another example, the transmitter 100 may receive, on the basis of a second signal received from the receiver 200, a first signal from the receiver 200 through the first communication channel 110.

FIG. 2 shows a communication structure of converting a display signal into a wireless signal for communication according to an embodiment.

Referring to FIGS. 1 and 2 together, a communication structure according to an embodiment may include a transmitter 100, a first wireless communication circuit 300 coupled to the transmitter 100, a receiver 200, and a second wireless communication circuit 400 coupled to the receiver 200. The configuration substantially the same as the above-described configuration uses the same reference numeral, and a redundant description will be omitted.

According to an embodiment, the first wireless communication circuit 300 may include a first convertor 301, a serializer circuit 302, a first radio-frequency integrated circuit (RFIC) 303, a third RFIC 304, and a first user logic 305.

According to an embodiment, the second wireless communication circuit 400 may include a second convertor 401, a deserializer circuit 402, a second RFIC 403, a fourth RFIC 404, and a second user logic 405.

According to an embodiment, the first wireless communication circuit 300 and the second wireless communication circuit 400 may perform millimeter wave (mmWave) communication through a first communication channel (for example, the first communication channel 110 of FIG. 1) and may perform UWB communication through a second communication channel (for example, the second communication channel 120 of FIG. 1), but are not limited thereto.

According to an embodiment, the first communication channel may include the first convertor 301, the serializer circuit 302, the first RFIC 303, the second RFIC 403, the deserializer circuit 402, and the second convertor 401.

According to an embodiment, the serializer circuit 302 and the deserializer circuit 402 may be replaced with a digital signal processor (DSP) circuit.

The first convertor 301 according to an embodiment may receive a display signal having a designated interface (for example, Vx1, DVI, USB-C, or DP) from the transmitter 100. For example, the display signal may include a differential signal (DS), but is not limited thereto. According to an embodiment, the first convertor 301 may convert a display signal received from the transmitter 100 into a digital signal. The first convertor 301 may convert a display signal into a digital signal and may transmit the digital signal to the serializer circuit 302.

According to an embodiment, the serializer circuit 302 may serialize a digital signal received from the first convertor 301. The serializer circuit 302 according to an embodiment may serialize a digital signal received from the first convertor 301 so that the digital signal is suitable for RF (radio frequency) communication. For example, the serializer circuit 302 may convert 10-bit parallel data received through the first convertor 301 into serial data.

According to an embodiment, the first RFIC 303 may convert a signal received from the serializer circuit 302 into a first RF signal and may transmit the first RF signal. The first RFIC 303 may convert a signal received from the serializer circuit 302 into a first RF signal that is used in a first network (for example, mmWave network) and is transmitted and received through the first communication channel. For example, the first RFIC 303 may convert a signal received from the serializer circuit 302 into a signal in an mmWave band, which ranges from GHz to 300 GHz, but the frequency band is not necessarily limited thereto. According to an embodiment, the first RFIC 303 may transmit a first RF signal to the second RFIC 403.

According to an embodiment, the second RFIC 403 may receive a first RF signal from the first RFIC 303. According to an embodiment, the second RFIC 403 may convert a first RF signal received from the first RFIC 303 into serial data. The second RFIC 403 may convert a first RF signal received from the first RFIC 303 into serial data and may provide the serial data to the deserializer circuit 402.

According to an embodiment, the deserializer circuit 402 may parallelize serial data. The deserializer circuit 402 according to an embodiment may convert serial data received through the second RFIC 403 into 10-bit parallel data.

The second convertor 401 according to an embodiment may receive parallel data from the deserializer circuit 402. The second convertor 401 may convert a digital signal into a display signal and may transmit the display signal to the receiver 200. The second convertor 401 may convert parallel data received from the deserializer circuit 402 into a display signal having a designated interface (for example, Vx1, DVI, USB-C, or DP). For example, the display signal may include a differential signal (DS), but is not limited thereto.

According to an embodiment, the second communication channel may include the third RFIC 304, the fourth RFIC 404, the first user logic 305, and the second user logic 405.

The first user logic 305 and the second user logic 405 according to an embodiment may be timing controllers, but are not limited thereto. For example, the receiver 200 may transmit control data and timing data to the second user logic 405.

According to an embodiment, the second user logic 405 may receive a control signal from the receiver 200. The second user logic 405 may provide the control signal to the fourth RFIC 404. For example, the second user logic 405 may transmit the control signal received from the receiver 200 to the fourth RFIC 404. According to another embodiment (not shown), the second user logic 405 may modulate a control signal received from the receiver 200, and may transmit the control signal resulting from modulation to the fourth RFIC 404.

According to an embodiment, the fourth RFIC 404 may convert a control signal received from the second user logic 405 into a second RF signal. The fourth RFIC 404 may convert a control signal into a second RF signal that is used in a second network (for example, UWB network) and is transmitted and received through the second communication channel. The fourth RFIC 404 may provide the third RFIC 304 with the second RF signal resulting from conversion. For example, the fourth RFIC 404 may convert a signal received from the second user logic 405 into a signal in an UWB band that includes a band ranging from 3 GHz to 30 GHz. The fourth RFIC 404 may transmit the second RF signal to the third RFIC 304.

According to an embodiment, the third RFIC 304 may receive a second RF signal from the fourth RFIC 404. According to an embodiment, the third RFIC 304 may convert a second RF signal received from the fourth RFIC 404 into a control signal. The third RFIC 304 may convert a second RF signal received from the fourth RFIC 404 into a control signal and may provide the control signal to the first user logic 305.

According to an embodiment, the first user logic 305 may provide the transmitter 100 with a control signal received from the third RFIC 304.

According to an embodiment, a wireless data transmission method may include: converting a control signal received from an external device into a second RF signal having a second frequency band; transmitting and/or receiving the second RF signal; reconverting the second RF signal into the control signal; converting, in a transmitter on the basis of the control signal, a display signal into a first RF signal having a first frequency band distinct from the second frequency band; transmitting and/or receiving the first RF signal; and converting, in a receiver, the received first RF signal into the display signal.

According to an embodiment, the converting of the display signal into the first RF signal may include serializing data of the display signal, and the converting of the first RF signal into the display signal may include deserializing data of the first RF signal.

According to an embodiment, the first frequency band may include a band ranging from 30 GHz to 300 GHz band, and the second frequency band may include a band ranging from 3 GHz to GHz.

According to an embodiment, the first frequency band and the second frequency band may include the same frequency band ranging from 3 GHz to 300 GHz, and may also include a frequency band of 300 GHz or higher.

According to an embodiment, the display signal may include a differential signal.

According to an embodiment, the wireless data transmission method may further include receiving the display signal from the external device.

According to an embodiment, an electronic device with a transmitter and a receiver may include: a first communication channel for transmitting and receiving a first RF signal in a first frequency band between the transmitter and the receiver; and a second communication channel for transmitting and receiving a second RF signal in a second frequency band distinct from the first frequency band between the transmitter and the receiver, wherein the first communication channel may include: a first convertor, in the transmitter, for converting a display signal into a digital signal; a first radio-frequency integrated circuit (RFIC) for converting the digital signal into the first RF signal and transmitting the first RF signal; a second RFIC, in the receiver, for receiving the first RF signal and converting the first RF signal into the digital signal; and a second convertor for converting the digital signal into the display signal, and wherein the second communication channel may include: a third RFIC, in the transmitter, for converting a control signal into the second RF signal and transmitting the second RF signal; and a fourth RFIC, in the receiver, for receiving the second RF signal and converting the second RF signal into the control signal.

According to an embodiment, the transmitting and/or the receiving of the first RF signal through the first communication channel may be performed on the basis of the control signal.

According to an embodiment, the first frequency band may include a band ranging from 30 GHz to 300 GHz band, and the second frequency band may include a band ranging from 3 GHz to GHz.

According to an embodiment, the third RFIC may include a serializer circuit for converting the digital signal into the Second RF signal, and the fourth RFIC may include a deserializer circuit for converting the Second RF signal into the digital signal.

According to an embodiment, a DSP circuit may be included instead of the serializer circuit and the deserializer circuit.

According to an embodiment, the display signal may include a differential signal.

According to an embodiment, the electronic device may further include a connector and a controller for connection to an external device.

Although various embodiments of the present disclosure have been described, the present disclosure is not necessarily limited thereto and those skilled in the art will understand that various substitutions, changes, and modifications may be made without departing from the scope of the present disclosure.

1. A wireless data transmission method, comprising:
converting a control signal received from an external device into a second RF signal having a second frequency band;
transmitting and/or receiving the second RF signal;
reconverting the second RF signal into the control signal;
converting, in a transmitter on the basis of the control signal, a display signal into a first RF signal having a first frequency band distinct from the second frequency band;
transmitting and/or receiving the first RF signal; and
converting, in a receiver, the received first RF signal into the display signal.

2. The wireless data transmission method of claim 1, wherein the converting of the display signal into the first RF signal comprises serializing data of the display signal, and
the converting of the first RF signal into the display signal comprises deserializing data of the first RF signal.

3. The wireless data transmission method of claim 2, further comprising
serializing and/or deserializing data through a DSP circuit.

4. The wireless data transmission method of claim 1, wherein the first frequency band comprises a band ranging from GHz to 300 GHz, and
the second frequency band comprises a band ranging from 3 GHz to 30 GHz.

5. The wireless data transmission method of claim 1, wherein the display signal comprises a differential signal.

6. The wireless data transmission method of claim 1, further comprising
receiving the display signal from the external device.

7. An electronic device with a transmitter and a receiver, the electronic device comprising:
a first communication channel for transmitting and receiving a first RF signal in a first frequency band between the transmitter and the receiver; and
a second communication channel for transmitting and receiving a second RF signal in a second frequency band distinct from the first frequency band between the transmitter and the receiver,
wherein the first communication channel comprises:
a first convertor, in the transmitter, for converting a display signal into a digital signal,
a first radio-frequency integrated circuit (RFIC) for converting the digital signal into the first RF signal and transmitting the first RF signal,
a second RFIC, in the receiver, for receiving the first RF signal and converting the first RF signal into the digital signal, and
a second convertor for converting the digital signal into the display signal, and
the second communication channel comprises:
a third RFIC, in the transmitter, for converting a control signal into the second RF signal and transmitting the second RF signal, and
a fourth RFIC, in the receiver, for receiving the second RF signal and converting the second RF signal into the control signal.

8. The electronic device of claim 7, wherein the transmitting and/or the receiving of the first RF signal through the first communication channel is performed on the basis of the control signal.

9. The electronic device of claim 7, wherein the first frequency band comprises a band ranging from 30 GHz to 300 GHz, and
the second frequency band comprises a band ranging from 3 GHz to 30 GHz.

10. The electronic device of claim 7, wherein the third RFIC comprises a serializer circuit for converting the digital signal into the Second RF signal, and
the fourth RFIC comprises a deserializer circuit for converting the Second RF signal into the digital signal.

11. The electronic device of claim 10, further comprising
a DSP circuit instead of the serializer circuit and the deserializer circuit.

12. The electronic device of claim 7, wherein the display signal comprises a differential signal.

13. The electronic device of claim 7, further comprising
a connector and a controller for connection to an external device.
